(19) United States
(12) Patent Application Publication
(10) Pub. No.: US 2020/0200074 A1
(43) Pub. Date: Jun. 25, 2020

(54) MULTIPLE STAGE TURBO-CHARGED ENGINE SYSTEM

(71) Applicant: GM Global Technology Operations LLC, Detroit, MI (US)

(72) Inventor: Cesare Maria Meano, Torino (IT)

(21) Appl. No.: 16/229,045

(22) Filed: Dec. 21, 2018

(51) Int. Cl. F02B 39/10; F02B 37/10; F02B 37/12; F02B 39/12; F02C 6/12

(52) U.S. Cl. CPC F02B 39/10; F02B 37/10; F02B 37/127; F01D 17/14; F02C 6/12; F05D 2220/40; F02B 39/12

(57) ABSTRACT

An engine system includes an internal combustion engine and a first and second air charge system. The internal combustion engine comprises an air intake system and an exhaust manifold. The first air charge system comprising a first compressor, a turbine, and a generator/motor module. The first compressor has a first air inlet, a first air outlet, and a first input shaft. The first outlet is connected to the air intake system, the turbine has an exhaust gas inlet, and the exhaust gas inlet is connected to an outlet of the exhaust manifold. The second air charge system includes a second compressor and an electric motor. The second compressor has a second air inlet, a second air outlet, and a second input shaft. The electric motor has an outlet shaft directly coupled for common rotation with the first input shaft of the second compressor.

### INTRODUCTION

The present disclosure relates generally to internal combustion engines and more particularly to turbo-charged engines having multiple stage air charging.

The efficiency of an internal combustion engine (ICE), in terms of units of power per displacement volume, can be greatly improved by adding a device to the ICE designed to increase the amount of air in the cylinders of the ICE. Such devices include but are not limited to turbo-chargers, super-chargers, and naturally aspirated intake systems designed to increase a “ram-air” effect. While there are varying benefits associated with each device, the desired result of improved power and torque is realized to varying degrees due to inherent shortcomings of the devices. Often, the choice of which device to employ is based on the planned application of the ICE. Thus, for a specific application there may be one or more type of air charge solution that best fits the purpose.

Accordingly, there is a need in the art for improved ICE having an air charge system that eliminates the shortcomings of previous air charge systems. Most specifically, a new design will improve the available power and torque across the entire ICE operating range and at variable engine loads.

### SUMMARY

The present disclosure includes an example of an engine system for a vehicle. The engine system includes an internal combustion engine, a first air charge system, a second air charge system, and an engine control module. The internal combustion engine comprises an air intake system and an exhaust manifold. The first air charge system comprises a first compressor, a turbine, and a generator/motor module. The first compressor has a first air inlet, a first air outlet, and a first input shaft. The first outlet is connected to the air intake system, the turbine has an exhaust gas inlet, and the exhaust gas inlet is connected to an outlet of the exhaust manifold.

The second air charge system includes a second compressor and an electric motor. The second compressor has a second air inlet, a second air outlet, and a second input shaft. The second outlet is connected to the first inlet of the first compressor. The electric motor has an outlet shaft directly coupled for common rotation with the first input shaft of the second compressor.

The engine control module includes a first electrical connection with the generator/motor module of the first air charge system and a second electrical connection with the electric motor of the second air charge system. The engine control module further includes a control logic for operating the engine system in at least a first and a second mode of control.

In one example of the present disclosure, the second air charge system further comprises a by-pass valve having a third air inlet and a third air outlet. The third air outlet is in communication with the second air outlet of the second compressor and the first air inlet of the first compressor.

In another example of the present disclosure, the generator/motor module of the first air charge system is electrically connected to the electric motor of the second air charge system.

In yet another example of the present disclosure, the turbine of the first air charge system further includes an output shaft drivingly connected to each of a first input shaft of the generator/motor module and a second input shaft of the first compressor.

In yet another example of the present disclosure, the first mode of control comprises providing electrical power to the electric motor of the second air charge system from the generator/motor module of the first air charge system.

In yet another example of the present disclosure, the second mode of control comprises providing electrical power to the electric motor of the second air charge system from one of the generator/motor module of the first air charge system and a vehicle electrical system.

In yet another example of the present disclosure, the first mode of control comprises providing electrical power to the electric motor of the second air charge system only from the generator/motor module of the first air charge system.

In yet another example of the present disclosure, the turbine of the first air charge system is a variable geometry turbine capable of providing a plurality of output torques through the second output shaft given a constant flow of exhaust gas from the exhaust manifold.

In yet another example of the present disclosure, the engine system further includes a charge air cooler having a fourth air inlet and a fourth air outlet. The fourth air inlet is in communication with the first air outlet of the first compressor and the fourth air outlet is in communication with the air intake system of the internal combustion engine.

The present disclosure includes another example of an engine system for a vehicle. The engine system includes an internal combustion engine, a first air charge system, a second air charge system, a by-pass valve, and an engine control module. The internal combustion engine includes an air intake system and an exhaust manifold.

The first air charge system comprises a first compressor, a turbine, and a generator/motor module. The first compressor has a first air inlet, a first air outlet, and a first input shaft. The first outlet is connected to the air intake system. The turbine has an exhaust gas inlet connected to an outlet of the exhaust manifold. The first turbine is a variable geometry turbine.

The second air charge system comprises a second compressor and an electric motor. The second compressor has a second air inlet, a second air outlet, and a second input shaft. The second outlet is connected to the first inlet of the first compressor, and the electric motor has an outlet shaft directly coupled for common rotation with the first input shaft of the second compressor.

The by-pass valve has a third air inlet and a third air outlet. The third air outlet is in communication with the second air outlet of the second compressor and the first air inlet of the first compressor.

The engine control module has electrical connections with the generator/motor module of the first air charge system and the electric motor of the second air charge system. The engine control module further includes a control logic for operating the engine system in at least a first and a second mode of control.

In one example of the present disclosure, the generator/motor module of the first air charge system is electrically connected to the electric motor of the second air charge system.

In another example of the present disclosure, the turbine of the first air charge system further includes an output shaft drivingly connected to each of a first input shaft of the generator/motor module and a second input shaft of the first compressor.

In yet another example of the present disclosure, the first mode of control comprises providing electrical power to the electric motor of the second air charge system from the generator/motor module of the first air charge system.

In yet another example of the present disclosure, the second mode of control comprises providing electrical power to the electric motor of the second air charge system from one of the generator/motor module of the first air charge system and a vehicle electrical system.

In yet another example of the present disclosure, the first mode of control comprises providing electrical power to the electric motor of the second air charge system only from the generator/motor module of the first air charge system.

In yet another example of the present disclosure, the turbine of the first air charge system is capable of providing a plurality of output torques through the second output shaft given a constant flow of exhaust gas from the exhaust manifold.

In yet another example of the present disclosure, the engine system further comprising a charge air cooler having a fourth air inlet and a fourth air outlet. The fourth air inlet is in communication with the first air outlet of the first compressor and the fourth air outlet is in communication with the air intake system of the internal combustion engine.

The present disclosure includes another example of an engine system for a vehicle. The engine system includes an internal combustion engine, a first air charge system, a second air charge system, a by-pass valve, a charge air cooler, and an engine control module. The internal combustion engine includes an air intake system and an exhaust manifold.

The first air charge system comprises a first compressor, a turbine, and a generator/motor module. The first compressor has a first air inlet, a first air outlet, and a first input shaft. The first outlet is connected to the air intake system. The turbine has an exhaust gas inlet and an output shaft. The exhaust gas inlet is connected to an outlet of the exhaust manifold. The output shaft is drivingly connected to each of the first input shaft of the first compressor and a second input shaft of the generator/motor module. The turbine is a variable geometry turbine.

The second air charge system includes a second compressor and an electric motor. The second compressor has a second air inlet, a second air outlet, and a second input shaft. The second outlet is connected to the first inlet of the first compressor. The electric motor has an outlet shaft directly coupled for common rotation with the first input shaft of the second compressor. The generator/motor module of the first air charge system is electrically connected to the electric motor of the second air charge system.

The by-pass valve comprises a third air inlet and a third air outlet, and wherein the third air outlet is in communication with the second air outlet of the second compressor and the first air inlet of the first compressor. The charge air cooler has a fourth air inlet and a fourth air outlet, and wherein the fourth air inlet is in communication with the first air outlet of the first compressor and the fourth air outlet is in communication with the air intake system of the internal combustion engine.

The engine control module includes electrical connections with the generator/motor module of the first air charge system and the electric motor of the second air charge system. The engine control module further includes a control logic for operating the engine system in at least a first and a second mode of control.

In one example of the present disclosure, the first mode of control comprises providing electrical power to the electric motor of the second air charge system only from the generator/motor module of the first air charge system.

In another example of the present disclosure, the second mode of control comprises providing electrical power to the electric motor of the second air charge system from one of the generator/motor module of the first air charge system and a vehicle electrical system.

The above features and advantages and other features and advantages of the present disclosure are readily apparent from the following detailed description when taken in connection with the accompanying drawings.

### BRIEF DESCRIPTION OF THE DRAWING

The drawing described herein is for illustration purposes only and is not intended to limit the scope of the present disclosure in any way.

FIG. 1 is a schematic of a multiple stage turbo-charged internal combustion engine according to the principles of the present disclosure.

### DESCRIPTION

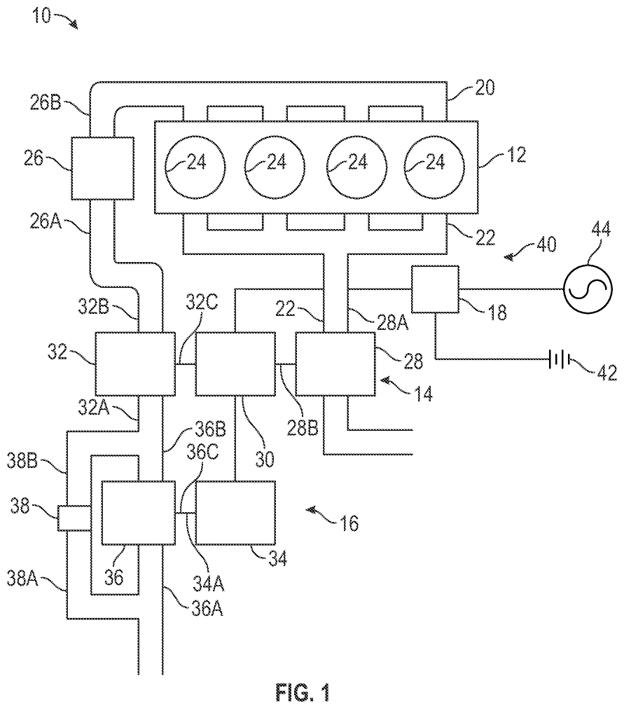

Examples of the present disclosure advantageously provide an internal combustion engine system 10 for a vehicle. Referring to the drawings, wherein like reference numbers refer to like components, FIG. 1 illustrates an engine system 10 that will now be described. The engine system 10 includes an internal combustion engine (ICE) 12, a first air charge system 14, a second air charge system 16, and an engine control module 18. The ICE 12 shown is an inline four cylinder example having an air intake system 20 and an exhaust manifold 22 in addition to the four cylinders 24. Although shown as an inline four cylinder engine, other variations of both the number of cylinders and the arrangement of the cylinders are contemplated by the disclosure without falling outside the scope of the disclosure. For example, 2, 6, 8, 10 or more cylinders may be arranged in an inline, “V”, flat, or “W” arrangement without departing from the scope of the disclosure.

The air intake system 20 communicates incoming air between the first and second air charge systems 14, 16 and the four cylinders 24. The exhaust manifold 22 communicates exhaust gasses from the four cylinders 24 to the first air charge system 14. The engine system 10 further includes a charge air cooler module 26 disposed and in communication with the first and second air charge systems 14, 16 and the air intake system 20. The charge air cooler module 26 provides a temperature decrease in the incoming charge air which improves volumetric efficiency of the ICE 12.

The first air charge system 14 includes a turbine 28, an electric generator/motor module 30, and a first compressor 32. The turbine 28 includes an exhaust gas input 28A and an output shaft or member 28B. The output shaft 28B is mechanically connected to and drives the generator/motor module 30. The generator/motor module 30 is mechanically connected to and drives the first compressor 32. The turbine 28 is in downstream communication with the exhaust manifold 22 and is driven by expanding exhaust gasses from the ICE 12 provided to the exhaust gas input 28A of the turbine 28 via the exhaust manifold 22. The turbine 28 thus drives the generator/motor module 30 and the first compressor 32. The first compressor 32 includes a first air inlet 32A, a first air outlet 32B, and an input shaft or member 32C. The first air outlet 32B of the first compressor 32 is in communication with charge air cooler 26 and the air intake system 20. The first air inlet 32A is in downstream communication with the second air charge system 16. Furthermore, the first compressor 32 is a variable geometry compressor that is adjustable according to particular inputs and operating parameters.

The second air charge system 16 includes an electric motor 34, a second compressor 36, and a bypass valve 38. The electric motor 34 includes an output shaft or member 34A that is mechanically connected to drive the second compressor 36. The second compressor 36 includes a second air inlet 36A, a second air outlet 36B, and an input shaft or member 36C. The second air outlet 36B of the second compressor 36 is in communication with the first air inlet 32A of the first compressor 32. The bypass valve 38 includes a third air inlet 38A and a third air outlet 38B and is disposed parallel with the second compressor 36. The bypass valve 38 allows for air flow to the first air inlet 32A of the first compressor 32 in the case that the second compressor 36 is not operating. However, other arrangements are possible for allowing the first compressor 32 to operate when the second compressor 36 is not powered. For example, a one-way clutch may be placed between the electric motor 34 and the second compressor 36 so that the second compressor 36 may spin freely when the first compressor 32 is pulling charge air through the second compressor 36. The second air charge system 16 may be designated as a low pressure charge system or a high pressure charge system depending upon the application of the ICE 10.

The generator/motor module 30 of the first air charge system 14 is electrically connected to the motor 34 of the second air charge system 16. In this manner, the motor 34 of the second air charge system 16 is capable of receiving power generated by the generator/motor 30 of the first air charge system 14 and driving the second compressor 36. Each of the generator/motor module 30 and the electric motor 34 are further connected to the vehicle electrical system 40 through the engine control module 18. The vehicle electrical system 40 may run off battery power 42 and alternator power 44 and thus the first and second air charge systems 14, 16 may run off battery and alternator power 42, 44. Additionally, if the available power from the vehicle electrical system 40 is not enough to run the electric motor 34 of the second air charge system 16, the electric motor 34 can run off the power generated by the generator/motor module 30 of the first air charge system 14.

The engine control module 18 is in electrical communication with the generator/motor module 30 of the first air charge system 14 and the electric motor 34 of the second air charge system 16. The engine control module 18 is preferably an electronic control device having a preprogrammed digital computer or processor, control logic, memory used to store data, and at least one I/O peripheral. The control logic includes a plurality of logic routines for monitoring, manipulating, and generating data. The engine control module 18 controls the operation of the engine system 10. The control logic may be implemented in hardware, software, or a combination of hardware and software. For example, control logic may be in the form of program code that is stored on the electronic memory storage and executable by the processor. The engine control module 18 receives the output signals of several sensors throughout the transmission and engine, performs the control logic and sends command signals to the engine system 10. The engine system 10 receives command signals from the engine control module 18 and converts the command signals to control actions operable in the engine system 10. Some of the control actions include but are not limited to increasing ICE 12 speed, changing air/fuel ratio, changing transmission 14 gear ratios, etc., among many other control actions.

For example, a control logic implemented in software program code that is executable by the processor of the engine control module 18 includes control logic for implementing a method of operating the engine system 10 including the first and second air charging systems 14, 16 as previously described. A number of control strategies are capable with the present disclosure. For example, variable geometry of the turbine 28 is controllable by setting the position at which the variable geometry achieves the best compromise between enthalpy extraction and pumping losses or exhaust backpressure. The boost provided by the first compressor 32 may be controlled by assisting or supplementing the first compressor 32 using the generator/motor module 30 in addition to the available turbine 28 torque. Additionally, the overall boost provided by the first and second air charge systems 14, 16 is controlled by the available boost provided by the first air charge system 14 and supplemented by the boost available from the second air charge system 16.

In practice, one strategy for controlling the engine system 10 includes a first or low load control and a second or high load control. At low loads, the second compressor 36 is disabled and circumvented via the bypass valve 38 and the first air charge system 14 operates as a turbine driven compressor. Additionally, if there is power available from the vehicle electrical system 40 each of the first compressor 32 and the second compressor 36 may be run optimally achieving the most desirable boost.

At high loads, the variable geometry position of the turbine 28 targets maximum enthalpy extraction and the generator/motor module 30 produces power to drive the second compressor 36 through the electric motor 34. The second compressor 36 acts as a low pressure (LP) compressor and the total boost is regulated by the combination of the first and second compressors 32, 36. Operating in this area, the first and second air charge systems 14, 16 are running without any power drawing from the vehicle electrical system 40. In this manner, the second air charge system 16 can be run continuously from the generator/motor module 30 of the first air charge system 14.

In balancing the engine system 10, sizing of the first and second compressors 32, 36 must be given consideration such that the desired result can be affected in a variety of load conditions. For example, the first air charge system 14 must be sized small enough to provide good part load and transient performance preferably using just the turbine 28 as the driver. The minimum size of the first compressor 32 needs to be sized so as to generate a maximum counter-pressure to avoid the risk of associated issues. The size of the second compressor 36 must be large enough to provide airflow for maximum power while still providing a suitable boost pressure to allow the first compressor 32 to handle the maximum power airflow. The second compressor 36 must be efficient enough to provide the required airflow while using just the electric power provided by the generator/motor module 30 of the first air charge system 14.

While examples have been described in detail, those familiar with the art to which this disclosure relates will recognize various alternative designs and examples for practicing the disclosed structure within the scope of the appended claims.

The following is claimed:

1. An engine system for a vehicle, the engine system comprising:
an internal combustion engine comprising an air intake system and an exhaust manifold;
a first air charge system comprising a first compressor, a turbine, and a generator/motor module, and wherein the first compressor has a first air inlet, a first air outlet, and a first input shaft, the first air outlet is connected to the air intake system, the turbine includes an exhaust gas inlet connected to the exhaust manifold;
a second air charge system comprising a second compressor and an electric motor, and wherein the second compressor has a second air inlet, a second air outlet, and a second input shaft, the second air outlet is connected to the first air inlet of the first compressor, and the electric motor has a first output shaft directly coupled for common rotation with the second input shaft of the second compressor, and
an engine control module comprising an electrical connection with each of the generator/motor module of the first air charge system and the electric motor of the second air charge system, and wherein the engine control module further includes a control logic for operating the engine system in at least a first control mode and a second control mode.

2. The engine system of claim 1 wherein the second air charge system further comprises a by-pass valve having a third air inlet and a third air outlet and the third air outlet is in communication with the second air outlet of the second compressor and the first air inlet of the first compressor.

3. The engine system of claim 1 wherein the generator/motor module of the first air charge system is electrically connected to the electric motor of the second air charge system.

4. The engine system of claim 1 wherein the turbine of the first air charge system further includes a second output shaft drivingly connected to each of a third input shaft of the generator/motor module and the first input shaft of the first compressor.

5. The engine system of claim 1 wherein the first control mode comprises providing electrical power to the electric motor of the second air charge system from the generator/motor module of the first air charge system.

6. The engine system of claim 5 wherein the second control mode comprises providing electrical power to the electric motor of the second air charge system from one of the generator/motor module of the first air charge system and a vehicle electrical system.

7. The engine system of claim 1 wherein the first control mode comprises providing electrical power to the electric motor of the second air charge system only from the generator/motor module of the first air charge system.

8. The engine system of claim 4 wherein the first turbine of the first air charge system is a variable geometry turbine capable of providing a plurality of output torques through the second output shaft given a constant flow of exhaust gas from the exhaust manifold.

9. The engine system of claim 1 further comprising a charge air cooler having a fourth air inlet and a fourth air outlet, and wherein the fourth air inlet is in communication with the first air outlet of the first compressor and the fourth air outlet is in communication with the air intake system of the internal combustion engine.

10. An engine system for a vehicle, the engine system comprising:
an internal combustion engine comprising an air intake system and an exhaust manifold;
a first air charge system comprising a first compressor, a turbine, and a generator/motor module, and wherein the first compressor has a first air inlet, a first air outlet, and a first input shaft, the first air outlet is connected to the air intake system, the turbine includes an exhaust gas inlet connected to the exhaust manifold, and the turbine is a variable geometry turbine;
a second air charge system comprising a second compressor and an electric motor, and wherein the second compressor has a second air inlet, a second air outlet, and a second input shaft, the second air outlet is connected to the first air inlet of the first compressor, and the electric motor has an outlet shaft directly coupled for common rotation with the second input shaft of the second compressor;
a by-pass valve comprising a third air inlet and a third air outlet, and wherein the third air outlet is in communication with the second air outlet of the second compressor and the first air inlet of the first compressor, and
an engine control module comprising an electrical connection with each of the generator/motor module of the first air charge system and the electric motor of the second air charge system, and wherein the engine control module further includes a control logic for operating the engine system in at least a first control mode and a second control mode.

11. The engine system of claim 10 wherein the generator/motor module of the first air charge system is electrically connected to the electric motor of the second air charge system.

12. The engine system of claim 11 wherein the turbine of the first air charge system further includes a second output shaft drivingly connected to each of a third input shaft of the generator/motor module and the first input shaft of the first compressor.

13. The engine system of claim 12 wherein the first control mode comprises providing electrical power to the electric motor of the second air charge system from the generator/motor module of the first air charge system.

14. The engine system of claim 13 wherein the second control mode comprises providing electrical power to the electric motor of the second air charge system from one of the generator/motor module of the first air charge system and a vehicle electrical system.

15. The engine system of claim 12 wherein the first control mode comprises providing electrical power to the electric motor of the second air charge system only from the generator/motor module of the first air charge system.

16. The engine system of claim 12 wherein the turbine of the first air charge system is capable of providing a plurality of output torques through the second output shaft given a constant flow of exhaust gas from the exhaust manifold.

17. The engine system of claim 16 further comprising a charge air cooler having a fourth air inlet and a fourth air outlet, and wherein the fourth air inlet is in communication with the first air outlet of the first compressor and the fourth air outlet is in communication with the air intake system of the internal combustion engine.

18. An engine system for a vehicle, the engine system comprising:
an internal combustion engine comprising an air intake system and an exhaust manifold;
a first air charge system comprising a first compressor, a turbine, and a generator/motor module, and wherein the first compressor has a first air inlet, a first air outlet, and a first input shaft, the first air outlet is connected to the air intake system, the turbine has an exhaust gas inlet and an output shaft, the exhaust gas inlet is connected to the exhaust manifold, the output shaft is drivingly connected to each of the first input shaft of the first compressor and a second input shaft of the generator/motor module, and the turbine is a variable geometry turbine;
a second air charge system comprising a second compressor and an electric motor, and wherein the second compressor has a second air inlet, a second air outlet, and a second input shaft, the second air outlet is connected to the first air inlet of the first compressor, the electric motor has an outlet shaft directly coupled for common rotation with the second input shaft of the second compressor, and the generator/motor module of the first air charge system is electrically connected to the electric motor of the second air charge system;
a by-pass valve comprising a third air inlet and a third air outlet, and wherein the third air outlet is in communication with the second air outlet of the second compressor and the first air inlet of the first compressor;
a charge air cooler having a fourth air inlet and a fourth air outlet, and wherein the fourth air inlet is in communication with the first air outlet of the first compressor and the fourth air outlet is in communication with the air intake system of the internal combustion engine, and
an engine control module comprising an electrical connection with each of the generator/motor module of the first air charge system and the electric motor of the second air charge system, and wherein the engine control module further includes a control logic for operating the engine system in at least a first control mode and a second control mode.

19. The engine system of claim 18 wherein the first control mode comprises providing electrical power to the electric motor of the second air charge system only from the generator/motor module of the first air charge system.

20. The engine system of claim 19 wherein the second control mode comprises providing electrical power to the electric motor of the second air charge system from one of the generator/motor module of the first air charge system and a vehicle electrical system.
